(19) United States
(12) Patent Application Publication
(10) Pub. No.: US 2025/0058260 A1
(43) Pub. Date: Feb. 20, 2025

(54) FILTER SYSTEM AND FILTER ELEMENT

(71) Applicant: MANN+HUMMEL GmbH, Ludwigsburg (DE)

(72) Inventors: Robert HASENFRATZ, Schwäbisch Hall (DE); Pascal NEEF, Trossingen (DE); Klaus-Dieter RUHLAND, Meckenheim (DE); Peter SAWATZKY, Römerberg (DE); Marco SCHILLING, Römerberg (DE)

(21) Appl. No.: 18/939,095

(22) Filed: Nov. 6, 2024

Related U.S. Application Data
(63) Continuation of application No. PCT/EP2023/062701, filed on May 12, 2023.

(30) Foreign Application Priority Data
May 18, 2022 (EP) 22173943.6

(51) Int. Cl. B01D 46/00; B01D 46/24; B01D 46/52

(52) U.S. Cl. CPC B01D 46/009; B01D 46/2414; B01D 46/521; B01D 2265/05

(57) ABSTRACT

A filter system and a filter element of the filter system having a recess arranged on an outside of the filter element and at least one coding element arranged on a circumference of an end cap of the filter element. At least one coding pin is arranged on an inside of a bottom housing part for cooperating with the recess when the filter element is inserted in the housing. The bottom housing part includes a circular shield having a slot extending in the axial direction, wherein the slot is configured to receive the coding element of the filter element when the filter element is inserted in the housing.

### CROSS-REFERENCE TO RELATED APPLICATIONS

This application is a continuation application of international application No. PCT/EP2023/062701 having an international filing date of May 12, 2023 and designating the U.S., the international application claiming a priority date of May 18, 2022 based on prior filed European patent application No. 22173943.6, the entire contents of the aforesaid international application and the aforesaid European patent application being incorporated herein by reference.

### FIELD

The invention relates to a filter system comprising a housing with a fluid inlet and a fluid outlet and a filter element being accommodated in the housing along an axial direction for filtering a fluid flowing from the fluid inlet to the fluid outlet, for example for air filter applications, and to a filter element comprising a filter bellows.

### BACKGROUND

WO 2020/014141 A1 discloses a filtration system comprising a housing having a first housing end and a second housing end. The housing defines a central compartment therein. The housing includes an alignment tab disposed on the second housing end. The alignment tab protrudes from the second housing end towards the first housing end. A filter element is positioned within the housing. The filter element includes a first end cap, a second end cap, and filter media positioned between and extending axially between the first end cap and the second end cap. The filter media defines a central opening extending axially therein. An alignment notch is disposed on the second end cap, the alignment notch protruding from the second end cap toward the first end cap.

U.S. Pat. No. 9,718,019 B2 discloses an air cleaner arrangement which comprises an air cleaner housing and a serviceable air filter cartridge. The air cleaner housing includes an air flow inlet arrangement and an air flow outlet arrangement. The air cleaner housing defines a housing interior and comprises a housing body and an access cover. A projection/receiver arrangement including first and second members is provided. One member of the projection/receiver arrangement is positioned on the access cover. Another member of the projection/receiver arrangement is positioned on the outer end surface of an end cap of the filter cartridge and is engageable with the access cover, in a defined manner. In general, the first and second members of the projection/receiver arrangement are engaged to provide cantilevered support of the air filter cartridge at the second end. The first and second members of the projection/receiver arrangement are also engaged in a non-rotatable manner.

### SUMMARY

It is an object of the invention to provide a filter system with a cost-effective provision of variants.

It is a further object of the invention to provide a filter element for such a filter system with a cost-effective provision of variants.

The aforementioned object is achieved according to a first aspect of the invention by a filter system comprising a housing with a fluid inlet and a fluid outlet and a filter element being accommodated in the housing along an axial direction for filtering a fluid flowing from the fluid inlet to the fluid outlet, the filter element comprising a filter bellows with a first end face and along the axial direction an opposite second end face, wherein at least one of the end faces comprises an end cap, wherein a recess is arranged on an outside of the first end face in at least the at least one end cap, the recess extending in the axial direction, wherein at least one coding element is arranged on a circumference of the at least one end cap, wherein at least one coding pin is arranged on an inside of a bottom housing part of the housing, the coding pin being configured for cooperating with the recess when the filter element is inserted in the housing, wherein the bottom housing part comprises a circular shield in a coaxial arrangement with the filter element, the shield comprising a slot extending in the axial direction, wherein the slot is configured to receive the coding element of the filter element when the filter element is inserted in the housing, wherein, with respect to the axial direction, a first angle between an angular position of the coding element of the filter element and an angular position of the recess matches a second angle between an angular position of the slot of the bottom housing part and an angular position of the coding pin.

The further object is achieved according to a second aspect of the invention by a filter element comprising a filter bellows with a first end face and along an axial direction an opposite second end face, wherein at least one of the end faces comprises an open end cap. The filter element is adapted to be used in a filter system according to the first aspect of the invention. A recess is arranged on an outside of the first end face in at least the at least one end cap, the recess extending in the axial direction, for cooperating with a coding pin of a housing of a filter system in an intended use. At least one coding element is arranged at an outer circumference of the at least one end cap, for cooperating with a slot of a circular shield of a bottom housing part of a filter system in an intended use, wherein, with respect to the axial direction, a first angle between an angular position of the coding element of the filter element and an angular position of the recess matches a second angle between an angular position of the slot of the bottom housing part and an angular position of the coding pin of the filter system. The coding element is arranged with a, for example predetermined, spacing along the axial direction from the first end face. The coding element can for example have a total extension in the axial direction that is significantly smaller than an extension of the filter bellows along the axial direction.

Exemplary embodiments, features and advantages of the present application are disclosed in the further description and the accompanying drawings.

According to a first aspect of the present application, a filter system is proposed, comprising a housing with a fluid inlet and a fluid outlet and a filter element being accommodated in the housing along an axial direction for filtering a fluid flowing from the fluid inlet to the fluid outlet. The filter element comprises a filter bellows with a first end face and along the axial direction an opposite second end face, wherein at least one of the end faces comprises an end cap. A recess is arranged on an outside of the first end face in at least the at least one end cap, the recess extending in the axial direction. At least one coding element is arranged on a circumference of the at least one end cap. At least one coding pin is arranged on an inside of a bottom housing part of the housing, the coding pin being configured for cooperating with the recess when the filter element is inserted in the housing. The bottom housing part comprises a circular shield in a coaxial arrangement with the filter element, the shield comprising a slot extending in the axial direction, wherein the slot is configured to receive the coding element of the filter element when the filter element is inserted in the housing, wherein, with respect to the axial direction, a first angle between an angular position of the coding element of the filter element and an angular position of the recess matches a second angle between an angular position of the slot of the bottom housing part and an angular position of the coding pin.

In a hollow cylinder-like filter element, a recess may be provided radially on the outside of the end face of the filter element. The recess may be wedge-shaped. The recess may penetrate the seal and/or the end plate in the axial direction, and potentially also partially the filter bellows. In case of a penetration of the seal, the penetration is for example partially such that a distance between penetration and sealing surface remains. The end cap may be fitted with a circumferential ring in the form of a crown, which consists of a large number of individual, for example uniformly spaced individual prongs or serrations. The contour of the serrations may be designed in such a way that a separate coding element, for example a radially protruding cam, can be detachably or non-detachably connected to the crown, for example by a snap-in connection. Depending on the prong on which the coding element is mounted, there is a defined angle between an angular position of the recess and the coding element. The number of available prongs thus results in the number of coding variants.

On the inside of the bottom housing part, a coding element, for example a coding pin, is mounted, whose design and size are matching and form-fitting to the recess in the filter element. The coding pin for example is a separate component and can for example be mounted on a predefined location at any angular position, for example by ultrasonic welding forming a welded joint. In addition, the bottom housing part has a circumferentially in the axial direction upstanding shield, with a defined distance to the outer diameter of the filter element. In this shield there is a vertical slot, matching the coding element of the filter element. Depending on the bolt position at which the coding element is attached, there is a defined angle between the coding element and the shield slot.

If the angle between the coding element and the recess, as well as between the coding pin and the shield slot, is the same, the filter element can be inserted into the bottom housing part. If the angles are different, mounting of the filter element is no longer possible. A change of the coding angle creates a new filter variant.

In contrast to state of the art, the coding, in this instance the interface between the housing of the filter system and the end cap of the filter element, is not located radially centered, but on the outside of the filter element, and the contour of the interface is not rotationally symmetrical. A further difference is that the coding engages not only in the seal and end cap, but also in the filter body.

The coding comprises at least two spatially separated elements at a defined angle on the outside of the filter element. Thus, a multitude of variants of the filter system and the filter element may be coded as separate variants.

Thus, lower overall costs for the simultaneous provision of many variants may be achieved by avoiding the need for a tooling effort, as no interchangeable inserts, no changeover, no tool change is needed.

Due to the exchangeable coding elements as coding element and coding pin, many different variants can be manufactured with the same tools and the same components.

By using different coding elements in design, size, etc., the number of coding variants can be increased many times over.

Small quantities of filter systems can be manufactured in connection with many possible variants without large production effort. Short delivery time to customers for new variants is achievable, because always the same single parts are used and therefore a high stock level is no problem for the production plant.

Differently coded filter elements and housings based on the same filter element and filter housing design can be provided without the need for expensive tool changes after start of production of the market product.

Complexity in the production process does not increase with increasing number of filter variants.

There is less risk of assembling the wrong part for a specific variant during the production chain since the variant is not created until the last production step.

There is less effort and costs for development, warehousing, and logistics, because each new variant still may remain the same product, concerning numbers, parts lists, etc., and may differ only by a different coding angle.

A bolt circle may be arranged in the bottom housing part, at least partly circumferentially around the axial direction, for accommodating the coding pin at the bottom housing part. Thus, the coding pin may be arranged on a defined angular position for coding the bottom housing part accordingly.

The at least one coding pin may be non-detachably connected to the bottom housing part, for example by welding or gluing. Additionally or alternatively, the at least one coding pin may form an integral part of the bottom housing part. By this way the variant of the filter system is fixed which prevents failures in mounting wrong filter elements in the housing of the filter system.

The recess of the filter element may be at least partly extending into the filter bellows. Further, the recess in the filter bellows may be formed by cutting the filter bellows, for example by laser cutting the filter bellows, or by spreading pleats of the filter bellows. Thus, reliable coding of the filter element may be achieved. Further, aligning of the filter element during the mounting process in the housing may be facilitated.

The at least one coding element may be non-detachably connected to the end cap. Additionally or alternatively, the at least one coding element may form an integral part of the at least one end cap. The coding element is fixed to the filter element such that it may not be loosened or be lost during handling of the filter element in stocks or during shipping for maintenance.

In exemplary embodiments of the filter system, an at least partially circumferential ring may be arranged at the at least one end cap, the circumferential ring providing a multitude of fixation elements, for example of uniformly spaced individual fixation elements, for accommodating the at least one coding element at the at least one end cap. Further, the at least one coding element may be connected to the fixation elements of the circumferential ring by a snap-in connection. By this way, defined angular positions of the coding element on the circumference of the filter element may be arranged ensuring a proper encoding of the filter element.

The at least partially circumferential ring may form an integral part of a center pipe of the filter element. Thus, ease of production of the filter element may be achieved with low costs. Less processes are necessary for mounting the filter element. However, other options are also possible, for example a detachable or non-detachable connection between the at least partially circumferential ring and a center pipe of the filter element or the at least partially circumferential ring and a center pipe of the filter element being unconnected, separate parts.

The at least partially circumferential ring may be molded into at least one end cap, wherein for example the center pipe is molded into the same end cap as well.

The at least one coding element may form an integral part of a center pipe of the filter element. Thus, ease of production of the filter element may be achieved with low costs. Less processes are therefore necessary for mounting the filter element.

According to a second aspect of the present application, a filter element is proposed, comprising a filter bellows with a first end face and along an axial direction an opposite second end face, wherein at least one of the end faces comprises an open end cap. The filter element is adapted to be used in a filter system according to the first aspect of the invention. A recess is arranged on an outside of the first end face in at least the at least one end cap, the recess extending in the axial direction, for cooperating with a coding pin of a housing of a filter system in an intended use. At least one coding element is arranged at an outer circumference of the at least one end cap, for cooperating with a slot of a circular shield of a bottom housing part of a filter system in an intended use, wherein, with respect to the axial direction, a first angle between an angular position of the coding element of the filter element and an angular position of the recess matches a second angle between an angular position of the slot of the bottom housing part and an angular position of a coding pin of the filter system. The coding element is arranged with a, for example predetermined, spacing along the axial direction from the first end face. The coding element can for example have a total extension in the axial direction that is significantly smaller than an extension of the filter bellows along the axial direction.

In exemplary embodiments the coding element can be arranged at an outer shell surface of the filter bellows.

In exemplary embodiments the coding element can be arranged with a predetermined spacing along the axial direction from a free end of the first end cap.

“Open end cap” herein means an end body that has at least one opening, for example a central opening, that allows fluid to be cleaned to be delivered to the filter bellows or cleaned fluid to be supplied from the filter bellows, for example to an inner hollow space that the filter bellows at least partially surrounds.

In a hollow cylinder-like filter element, a wedge-shaped recess may be provided radially on the outside of the end face of the filter element, which penetrates the seal and/or end plate in the axial direction, and potentially also partially the filter bellows. In case of a penetration of the seal, the penetration is for example partially such that a distance between penetration and sealing surface remains. The end cap may be fitted with a circumferential ring in the form of a crown, which consists of a large number of individual, for example uniformly spaced individual prongs or serrations. The contour of the serrations may be designed in such a way that a separate coding element, for example a radially protruding cam, can be detachably or non-detachably connected to the crown, for example by a snap-in connection. Depending on the prong on which the coding element is mounted, there is a defined angle between an angular position of the recess and the coding element. The number of available prongs thus results in the number of coding variants.

The proposed filter element may be used in a filter system as described above, ensuring a defined coding between the filter element and the housing of the filter system. The coding comprises two spatially separated elements, as the recess and the coding element of the filter element, at a defined angle on the outside of the filter element. Thus, a multitude of variants of the filter system and the filter element may be coded as separate variants.

The recess of the filter element may be at least partly extending into the filter bellows. In particular, the recess in the filter bellows may be formed by cutting the filter bellows, for example by laser cutting the filter bellows, or by spreading pleats of the filter bellows. Thus, reliable coding of the filter element may be achieved. Further, aligning of the filter element during the mounting process in the housing may be facilitated.

The at least one coding element may be non-detachably connected to the end cap and/or forms an integral part of the at least one end cap. The coding element is fixed to the filter element and may not be loosened or be lost during handling of the filter element in stocks or during shipping for maintenance.

An at least partially circumferential ring may be arranged at the at least one end cap, the circumferential ring providing a multitude of fixation elements, for example of uniformly spaced individual fixation elements, for accommodating the at least one coding element at the end cap. The at least one coding element may be connected to the fixation elements of the circumferential ring by a snap-in connection. By this way, defined angular positions of the coding element on the circumference of the filter element may be arranged ensuring a proper encoding of the filter element.

The at least partially circumferential ring may form an integral part of a center pipe of the filter element. Thus, ease of production of the filter element may be achieved with low costs. Less processes are necessary for mounting the filter element.

However, other options are also possible, for example a detachable or non-detachable connection between the at least partially circumferential ring and a center pipe of the filter element or the at least partially circumferential ring and a center pipe of the filter element being unconnected, separate parts.

The at least one coding element may form an integral part of a center pipe of the filter element. Thus, ease of production of the filter element may be achieved with low costs. Less processes are therefore necessary for mounting the filter element.

### BRIEF DESCRIPTION OF DRAWINGS

Exemplary embodiments of the present application are shown in the accompanying drawings. The drawings, the description, and the appended claims contain numerous features in combination. The person skilled in the art will expediently also consider the features individually and combine them into sensible further combinations.

FIG. 1 shows an isometric exploded view of a filter system according to an embodiment of the present application.

FIG. 2 shows another isometric exploded view of the filter system according to FIG. 1.

FIG. 3 shows an isometric view of a filter element according to an embodiment of the present application.

FIG. 4 shows an isometric view of a coding element of the filter element according to FIG. 3.

FIG. 5 shows an isometric view of a bottom housing part of the filter system according to FIG. 1.

FIG. 6 shows an isometric view of a coding pin of the bottom housing part of the filter system according to FIG. 1.

FIG. 7 shows a side view of the filter system according to FIG. 1 with an intersection plane A-A marked.

FIG. 8 shows a top view of the filter system according to FIG. 1 in the intersection plane A-A with an intersection plane C-C marked.

FIG. 9 shows another top view of the filter system according to FIG. 1.

FIG. 10 shows a side view of the filter system according to FIG. 1 in the intersection plane C-C.

### DETAILED DESCRIPTION

In the drawings, like elements are referred to with like reference numerals. The drawings are merely schematic representations, not intended to portray specific parameters of the present application. Moreover, the drawings are intended to depict only typical embodiments of the present application and therefore should not be considered as limiting the scope of the appended claims.

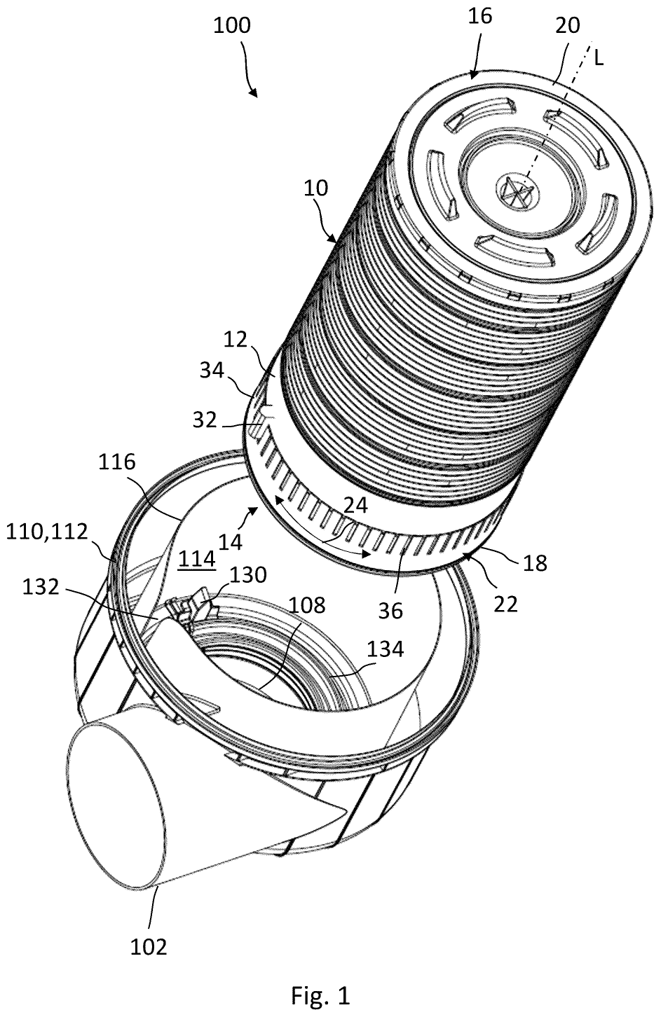

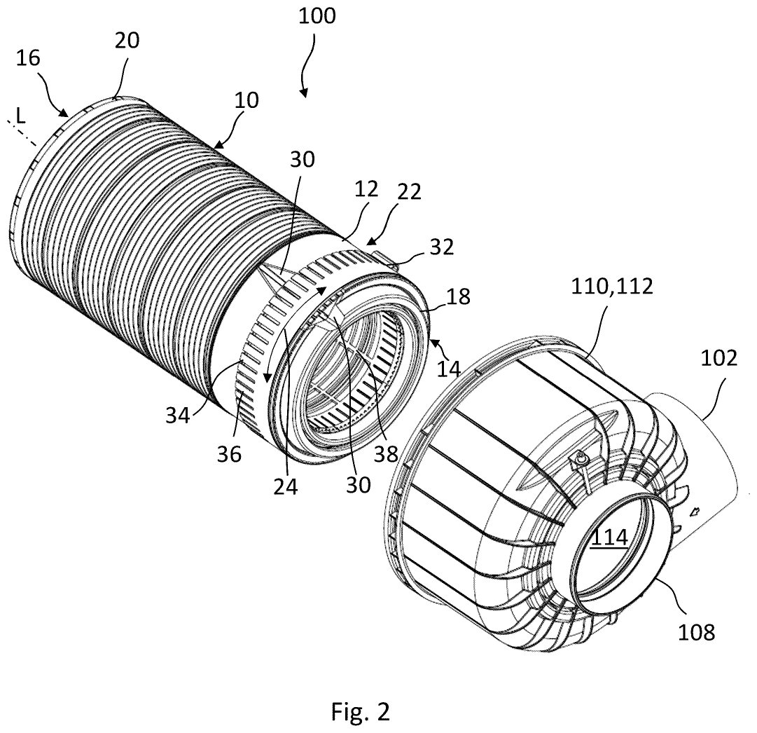

FIG. 1 and FIG. 2 show two isometric exploded views of a filter system 100 according to an embodiment of the present application, in two different perspectives. The filter system 100 may particularly be used for air filtering, for example in industrial applications.

The filter system 100 comprises a housing 110 with a fluid inlet 102 and a fluid outlet 108. Only a bottom housing part 112 is shown, where the fluid inlet 102 and the fluid outlet 108 may be located. An upper housing part for tightly closing the housing 110 is omitted. The filter system 100 further comprises a filter element 10 being accommodated in the housing 110 along an axial direction L for filtering a fluid, for example air, flowing from the fluid inlet 102 to the fluid outlet 108.

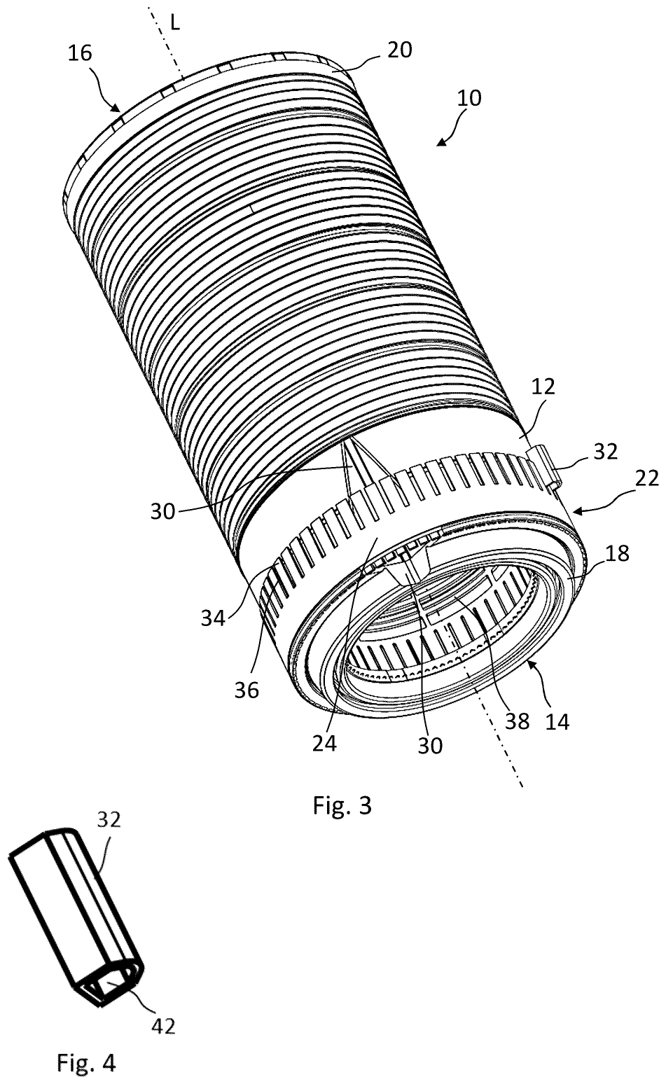

FIG. 3 shows an isometric view of the filter element 10 according to an embodiment of the present application.

The filter element 10 comprises a filter bellows 12 with a first end face 14 and along the axial direction L an opposite second end face 16. Both end faces 14, 16 comprise an end cap 18, 20 for a stable mounting and sealing in the housing 110. The end caps 18, 20 for example may be manufactured from foamed polyurethane (PUR) material or other sealing material, for example an elastomer. The filter bellows 12 for example may be manufactured from a pleated filter medium.

As shown in FIG. 3, a recess 30 is arranged on an outside 22 of the first end face 14 in the first end cap 18, which is an open end cap 18, the recess 30 extending in the axial direction L. The recess 30 of the filter element 10 is partly extending into the filter bellows 12. In particular, the recess 30 in the filter bellows 12 may be formed by cutting the filter bellows 12, for example by laser cutting the filter bellows 12. Alternatively, the recess 30 may be formed by spreading pleats of the filter bellows 12.

A coding element 32 is arranged on an outer circumference 24 of the open end cap 18. The coding element 32 is arranged with a predetermined spacing along the axial direction L from the first end face 14. The spacing between a proximal end of the coding element 32 that faces the first end face 14 and the first end face 14 may, for example, range between 5% and 25% of a total length of the filter bellows 12 in the axial direction L, for example between 7% and 15% of a total length of the filter bellows 12 in the axial direction L.

For this purpose, an at least partially circumferential ring 34 is arranged at the end cap 18. The circumferential ring 34 provides a multitude of fixation elements 36, for example of preferably uniformly spaced individual fixation elements 36, for accommodating the coding element 32 at the end cap 18. In particular, the coding element 32 may be connected to the fixation elements 36 of the circumferential ring 34, for example by a snap-in connection.

In another embodiment the at least partially circumferential ring 34 may form an integral part of a center pipe 38 of the filter element 10. The center pipe 38 supporting the filter bellows 12 is located on an inside of the filter element 10 as best shown in FIG. 2 and FIG. 3.

FIG. 4 shows an isometric view of the coding element 32 of the filter element 10. The coding element 32 is provided with an opening 42 for mounting the coding element 32 on the fixation elements 36 of the circumferential ring 34. The coding element 32 may be non-detachably fixed on the fixation element 36 by welding or gluing. Snap-in connection may also be possible.

The coding element 32 may be non-detachably connected to the end cap 18.

In an alternative embodiment the coding element 32 may directly form an integral part of the end cap 18.

In a further alternative embodiment, the coding element 32 may directly form an integral part of the center pipe 38 of the filter element 10.

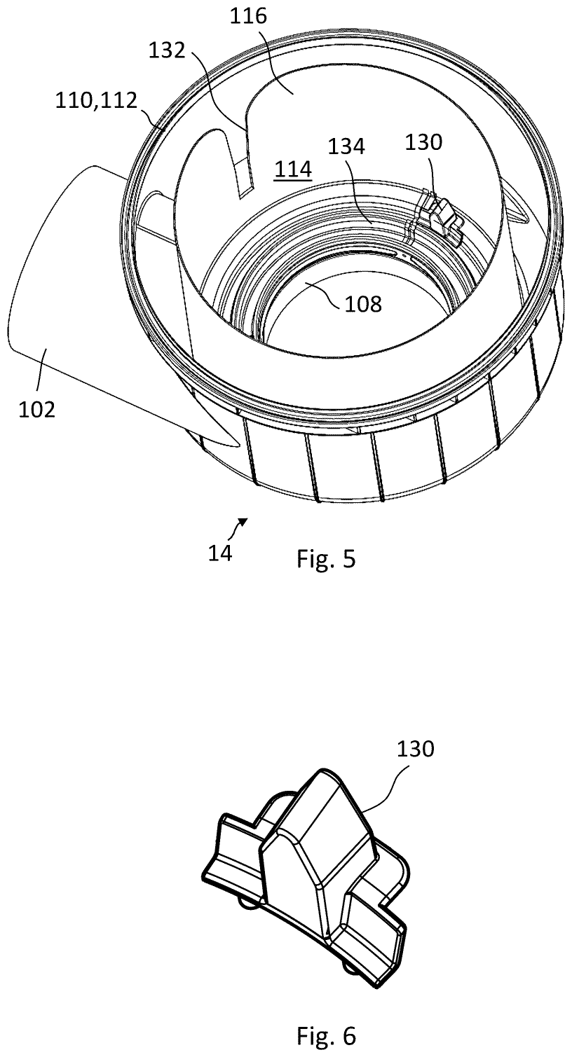

FIG. 5 shows an isometric view of a bottom housing part 112 of the filter system 100 according to FIG. 1.

A coding pin 130 is arranged on an inside 114 of the bottom housing part 112 of the housing 110. The coding pin 130 is configured for cooperating with the recess 30 when the filter element 10 is inserted in the housing 110.

A bolt circle 134 may be arranged in the bottom housing part 112, at least partly circumferentially around the axial direction L, for accommodating the coding pin 130 at the bottom housing part 112.

FIG. 6 shows an isometric view of the coding pin 130. The coding pin 130 may be non-detachably connected to the bottom housing part 112, for example by welding or gluing.

In an alternative embodiment the coding pin 130 may form an integral part of the bottom housing part 112.

As best shown in FIG. 1 and FIG. 5, the bottom housing part 112 further comprises a circular shield 116 in a coaxial arrangement with the filter element 10. The shield 116 is used for protection of the filter bellows 12 from for example particles in the fluid entering from the fluid inlet 102.

The shield 116 in the embodiment shown comprises a slot 132 extending in the axial direction L. The slot 132 is configured to receive the coding element 32 of the filter element 10 when the filter element 10 is inserted in the housing 110.

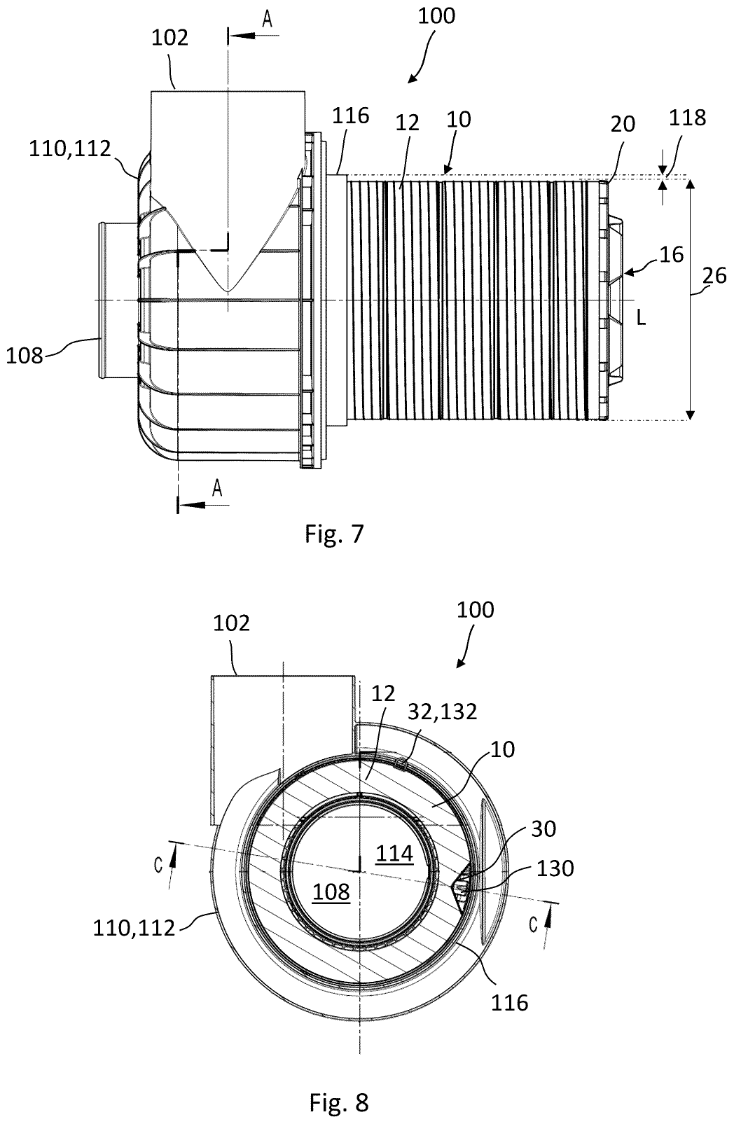

FIG. 7 shows a side view of the filter system 100 according to FIG. 1 with an intersection plane A-A marked.

In the side view in FIG. 7 the filter element 10 is mounted in an intended position in the bottom housing part 112. In this view the distance 118 between the shield 116 and the diameter 26 of the filter element 10 is marked.

FIG. 8 shows a top view of the filter system 100 in the intersection plane A-A of FIG. 7 with an intersection plane C-C marked.

In the top view in FIG. 8 the cooperation of the coding element 32 at the filter element 10 and the slot 132 of the shield 116 of the bottom housing part 112 as well as of the coding pin 130 of the bottom housing part 112 and the recess 30 in the filter element 10 is clearly seen when the filter element 10 is in its intended position in the bottom housing part 112.

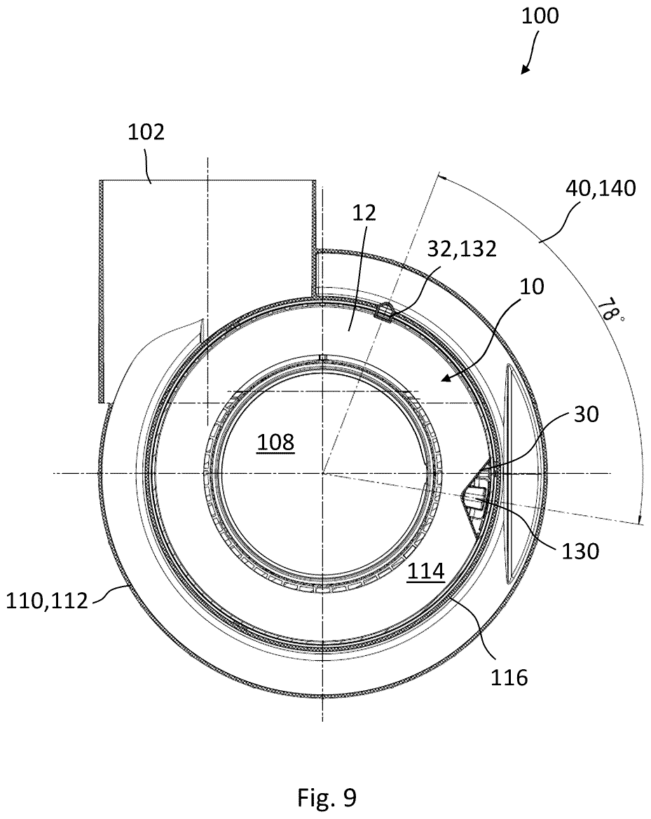

This cooperation is focused in FIG. 9 where another top view of the filter system 100 is shown. Here it is to be seen, that, with respect to the axial direction L, a first angle 40 between an angular position of the coding element 32 of the filter element 10 and an angular position of the recess 30 matches a second angle 140 between an angular position of the slot 132 of the bottom housing part 112 and an angular position of the coding pin 130. This matching is a requirement that the filter element 10 with defined recess 30 and coding element 32 can be inserted into the bottom housing part 112 with defined coding pin 130 and slot 132 in a correct position.

If an angle 40 between the coding element 32 and the recess 30, as well as between the coding pin 130 and the slot 132 of the shield 116, is the same, the filter element 10 can be inserted into the bottom housing part 112. If the angles 40, 140 are different, mounting of the filter element 10 is no longer possible. A change of the coding angles 40, 140 creates a new filter variant.

In the embodiment shown angles 40, 140 of 78° are chosen between the coding element 32 and the recess 30, as well as between the coding pin 130 and the slot 132, respectively.

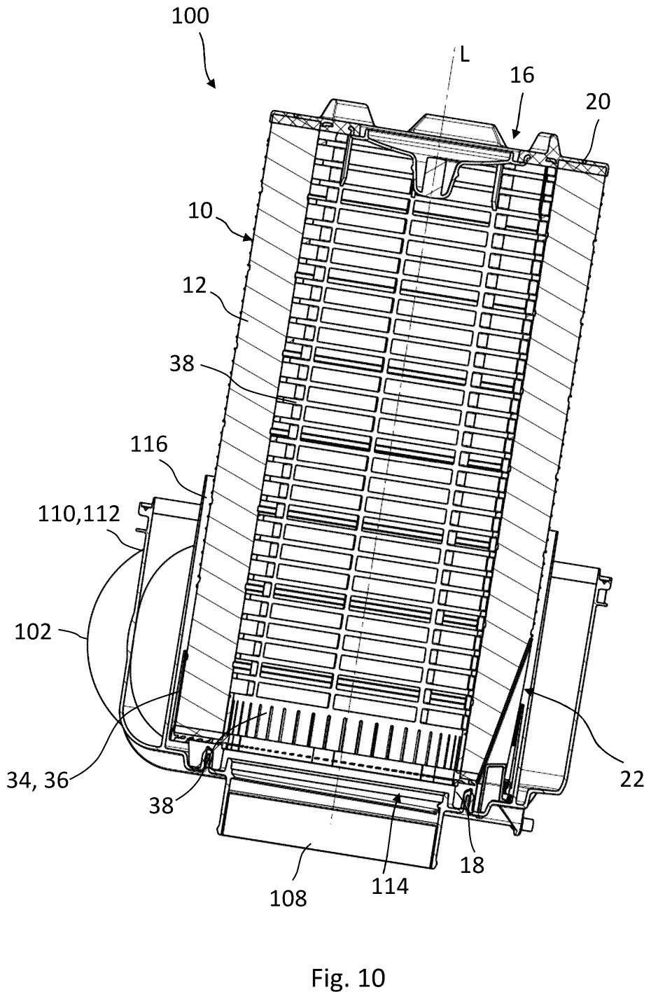

FIG. 10 shows a side view of the filter system 100 in the intersection plane C-C of FIG. 8. In this view the mounting of the filter element 10 at the bottom of the bottom housing part 112 is to be seen when the filter element 10 is in a final position in the housing 110 for an intended use of the filter system 100 when the housing 110 is closed by an upper housing part which is not shown.

### REFERENCE NUMERALS

10 filter element
12 filter bellows
14 end face
16 end face
18 end cap
20 end cap
22 outside
24 outer circumference
26 diameter
30 recess
32 coding element
34 circumferential ring
36 fixation element
38 center pipe
40 first angle
42 opening
100 filter system
102 fluid inlet
108 fluid outlet
110 housing
112 bottom housing part
114 inside
116 circular shield
118 distance
130 coding pin
132 slot
134 bolt circle
140 second angle
L axial direction

1. A filter system comprising a housing with a fluid inlet and a fluid outlet and a filter element accommodated in the housing along an axial direction for filtering a fluid flowing from the fluid inlet to the fluid outlet,
the filter element comprising a filter bellows with a first end face and along the axial direction an opposite second end face, wherein at least one of the first end face and the second end face comprises an end cap,
wherein a recess is arranged on an outside of the end cap, the recess extending in the axial direction,
wherein at least one coding element is arranged on a circumference of the end cap,
wherein at least one coding pin is arranged on an inside of a bottom housing part of the housing, the coding pin configured for cooperating with the recess when the filter element is inserted in the housing,
wherein the bottom housing part comprises a circular shield in a coaxial arrangement with the filter element, the shield comprising a slot extending in the axial direction, wherein the slot is configured to receive the coding element of the filter element when the filter element is inserted in the housing,
wherein, with respect to the axial direction, a first angle between an angular position of the coding element of the filter element and an angular position of the recess matches a second angle between an angular position of the slot of the bottom housing part and an angular position of the coding pin.

2. The filter system according to claim 1, wherein a bolt circle is arranged in the bottom housing part, at least partly circumferentially around the axial direction for accommodating the coding pin at the bottom housing part.

3. The filter system according to claim 1, wherein the at least one coding pin is non-detachably connected to the bottom housing part and/or the at least one coding pin forms an integral part of the bottom housing part.

4. The filter system according to claim 1, wherein the recess of the filter element is at least partly extending into the filter bellows, and wherein the recess in the filter bellows is formed by cutting the filter bellows or by spreading pleats of the filter bellows.

5. The filter system according to claim 1, wherein the at least one coding element is non-detachably connected to the end cap and/or forms an integral part of the end cap.

6. The filter system according to claim 1, wherein an at least partially circumferential ring is arranged at the end cap, the circumferential ring providing a multitude of fixation elements for accommodating the at least one coding element at the end cap, and wherein the at least one coding element is connected to a corresponding one of the fixation elements of the circumferential ring.

7. The filter system according to claim 6, wherein the at least partially circumferential ring forms an integral part of a center pipe of the filter element.

8. The filter system according to claim 6, wherein the at least one coding element forms an integral part of a center pipe of the filter element or the at least partially circumferential ring.

9. A filter element for a filter system comprising a filter bellows with a first end face and along an axial direction an opposite second end face, wherein at least one of the first end face and the second end face comprises an end cap,
wherein at least one recess is arranged on an outside of the end cap, the recess extending in the axial direction for cooperating with a coding pin of a housing of the filter system,
wherein at least one coding element is arranged at an outer circumference of the end cap for cooperating with a slot of a circular shield of a bottom housing part of the filter system, wherein the coding element is arranged with a spacing along the axial direction from the at least one of the first end face and the second end face, and wherein, with respect to the axial direction, a first angle between an angular position of the coding element of the filter element and an angular position of the recess matches a second angle between an angular position of the slot of the bottom housing part and an angular position of a coding pin of the filter system.

10. The filter element according to claim 9, wherein the recess of the filter element is at least partly extending into the filter bellows, and wherein the recess in the filter bellows is formed by cutting the filter bellows or by spreading pleats of the filter bellows.

11. The filter element according to claim 9, wherein the at least one coding element is non-detachably connected to the end cap and/or forms an integral part of the end cap.

12. The filter element according to claim 9, wherein an at least partially circumferential ring is arranged at the end cap, the circumferential ring providing a multitude of fixation elements for accommodating the at least one coding element at the end cap, and wherein the at least one coding element is connected to a corresponding one of the fixation elements of the circumferential ring.

13. The filter element according to claim 12, wherein the at least partially circumferential ring forms an integral part of a center pipe of the filter element.

14. The filter element according to claim 12, wherein the at least one coding element forms an integral part of a center pipe of the filter element or of the at least partially circumferential ring.
